(19) United States
(12) Patent Application Publication
(10) Pub. No.: US 2026/0188814 A1
(43) Pub. Date: Jul. 2, 2026

(54) UNDER-BATTERY VEHICLE ACCESS DEVICE

(71) Applicant: The Braun Corporation, Winamac, IN (US)

(72) Inventor: Eric Sajed Dosenbach, Indianapolis, IN (US)

(73) Assignee: The Braun Corporation, Winamac, IN (US)

(21) Appl. No.: 19/435,089

(22) Filed: Dec. 29, 2025

Related U.S. Application Data
(60) Provisional application No. 63/740,409, filed on Dec. 31, 2024.

(51) Int. Cl. H01M 50/242; B60K 1/04; H01M 50/249

(52) U.S. Cl. CPC H01M 50/242; B60K 1/04; H01M 50/249; B60K 2001/0438; H01M 2220/20

(57) ABSTRACT

An electrically powered passenger vehicle is provided with modifications to allow access to physically limited passengers through the use of a ramp assembly mounted below a battery. The ramp assembly may use one or more linear guides that deploy a ramp platform fully outside a ramp housing. A lifting mechanism may be provided to raise an inboard end of the ramp platform to meet with a vehicle entrance.

### CROSS REFERENCE TO OTHER APPLICATIONS

This application claims priority to U.S. Provisional Patent Application No. 63/740,409, filed on December 31, 2024, the contents of which are incorporated by reference herein. This application also incorporates by reference the contents of U.S. Patent Application No. 63/591,642, filed on 19 October 2023.

### FIELD OF THE DISCLOSURE

The present disclosure relates generally to a passenger vehicle that has been modified to allow access by a physically limited passenger, and in one embodiment, to a vehicle access device configured to mount underneath the vehicle at least partially and in some embodiments substantially below and underneath a battery of a battery electric vehicle.

### BACKGROUND

Automobile manufacturers do not currently mass-produce passenger motor vehicles specifically designed to transport passengers having physical limitations, either as a driver or as a non-driving passenger. Consequently, mass-produced passenger vehicles are modified, or retrofitted, by a number of aftermarket companies dedicated to supplying vehicles to physically limited passengers. Such vehicles can be modified by altering or adding certain parts or structures within a vehicle to accommodate the physically limited passenger without inconveniencing other passengers or sacrificing space in the vehicle. For example, in one configuration, a passenger vehicle may be retrofitted with a vehicle access device such as a ramp or a lift to enable a physically limited individual using a personal mobility device to enter and exit the vehicle.

In some cases, the vehicle access device is stored below the conventional vehicle floor and deploys to accommodate entry and exit of the physically limited individual through an entrance of the vehicle. This typically requires extensive modification such as removing the OEM floor and replacing it with a custom lowered floor. Modern electrically powered vehicles often store a battery below the vehicle floor, presenting challenges for the lowered floor method of modification. In other instances, a vehicle access device may stow inside the vehicle interior above the floor. While this simplifies the modification of the vehicle, it is often not desired to take up interior space for passengers or other cargo.

Installing a vehicle access device at least partially beneath a vehicle battery, as proposed herein, solves some of these design challenges but introduces several new design challenges. For instance, installing a vehicle access device at least partially below a vehicle battery significantly reduces the vehicle’s ground clearance and breakover angle, potentially causing hazards when operating the vehicle on roads with speed bumps, contours, or hazardous debris. Moreover, the vehicle access device must deploy in a manner that allows at least the in-board end to lift and meet the entrance threshold of the vehicle. The lifting mechanism on existing passenger vehicle ramps are typically designed to be installed directly under the floor surface and are therefore incapable of lifting the in-board end of the ramp platform a distance large enough to reach the entrance when the ramp is installed under the battery. Additionally, existing lifting mechanisms are not designed to function exterior of the ramp frame such that the in-board end of the ramp traverses a path that avoids contact with the battery as it lifts to the entrance threshold height.

### SUMMARY OF THE EMBODIMENTS

In one embodiment, passenger vehicle may be modified to include a ramp configured to move from a stowed position to a deployed position to allow entrance to physically limited passengers, such as wheelchaired passenger, herein referred to as mobility passengers. The vehicle may be partially or fully powered electrically. A battery may be provided to power the vehicle. The battery may be displaced below a floor of an interior cabin of the vehicle.

In one example of this embodiment, the ramp may be installed below the battery. The ramp may be secured with spacers that mount directly to the vehicle chassis. The spacers may provide a gap between the bottom of the battery and the top of the ramp frame to mitigate damage to the battery in the event the ramp contacts debris on the road.

In an example of this embodiment, the ramp may be guided by one or more linear guide rail mechanisms. To provide a thin stow profile, the ramp may be guided by two linear guide rail mechanisms, one on each side of a ramp platform. Each guide rail mechanism may include one or more linear guide rails configured to “telescope” or “cascade” when deploying. The linear guide rail mechanism may include a first linear guide rail.

In another example of this embodiment, the ramp may be moved between the stowed and deployed position via a drive motor. The drive motor may be coupled to a drive shaft. The drive shaft may extend at least the width of the ramp. The drive shaft may be coupled to at least one sprocket or pulley that is configured to transmit power from the drive shaft to a drive sprocket by a drive chain, a belt, or any other known method of power transmission. The drive shaft may include two sprockets mounted at a set distance along the drive shaft configured to transmit power to each linear guide mechanism on the side of the ramp platform. For clarity, only one side of the linear guide mechanisms is described, however, it can be appreciated that the other side linear guide rail functions substantially the same. A drive sprocket may be provided in a first linear guide rail of the guide rail mechanism and coupled via a first chain to an idle sprocket. The first linear guide rail may be fixedly mounted within a ramp housing configured to protect the components of the ramp assembly.

A second guide rail may be slidingly coupled to the first linear guide rail. The second guide rail may have one or more carriages that include one or more rollers that contact the first guide to control the linear motion of the second guide. The second guide may be fixedly attached to the first chain via a first chain bracket such that power applied to rotate the chain moves the second guide linearly. The second guide may have a first idle sprocket at a first end of the second guide and a second idle sprocket and a second end of the second guide. A second chain may be looped around the first and second idle sprockets of the second guide. The second chain may be fixedly connected via a second chain bracket to a static point in the ramp assembly, such as the first linear guide or the ramp housing. The second chain bracket may be configured such that the linear movement of the second guide causes the second chain bracket to hold the second chain still to induce rotation of the second chain about the first and second idle sprockets.

A ramp platform may be provided to allow the mobility passenger to traverse it to enter or exit the vehicle. The ramp platform may have side rails on either side of the platform higher than a platform surface to protect the mobility passengers from accidentally slipping off the side of the platform. The side rails of the platform may be coupled to the second chain via a lifting mechanism. The lifting mechanism may be configured to lift an inboard end of the ramp platform to meet an entry of the vehicle cabin. The lifting mechanism may be slidingly coupled to the second rail and guided via one or more rollers. The lifting mechanism may include two lifting arms, each rotatably coupled to a carriage having one or more rollers. The first lifting arm may be rotatably coupled to a first carriage at a first end, and rotatably coupled to the side rail of the ramp platform at a second end. The second lifting arm may be rotatably coupled to a second carriage at a first end, and rotatably coupled to the first lifting arm at a second end. The second lifting arm may be rotatably coupled to the first lifting arm between the first and second ends of the first lifting arm. The lifting arms may be configured such that in the fully lifted position, the second end of the first lifting arm may be rotated over the second end of the second lifting arm. By rotating over this point, the force transmitted by a mobility passenger using the ramp platform does not cause the lifting arms to go back to a collapsed configuration.

A stop may be provided to prevent one of the first or second carriages from traveling within the second guide rail passed a certain point. The stop may be a physical barrier in the second guide rail or a chain or rope anchored to a fixed point in the ramp assembly such as the ramp housing. Whichever of the first or second carriages is not configured to engage with the stop may be coupled to the second chain. For example, the second carriage may be configured to engage with the stop and the first carriage may be coupled to the second chain. As the second chain rotates, the first carriage may move the ramp platform. In the stowed configuration the first and second lifting arms may be collapse and substantially horizontal, pushing the first and the second carriages away from each other. When the drive motor operates to move the ramp from the stowed position to the deployed position, the second chain rotates and the first carriage may push the second carriage while staying in the collapsed position. Once the second carriage reaches the stop, the first carriage may still be induced to move my the second chain. This causes the first carriage to move towards the second carriage and cause the lifting arms to transfer from the collapsed position to a lifted position.

In an example of embodiment, the ramp assembly is stowed underneath the cabin floor of the vehicle. Therefore the ramp platform needs to deploy fully outside of the ramp housing, lift upwards, and then retract back towards the vehicle to support the inboard end of the ramp platform. The ramp platform may be suspended such that the lifting mechanism supports the weight of a mobility passenger, or the inboard end of the ramp may be retracted to rest on a door jamb of an entry to the vehicle cabin.

In another example of this embodiment, the vehicle may be modified to provide a ledge configured for the inboard end of the ramp to rest upon in the deployed position.

In one example of this embodiment, the battery may be narrower than the vehicle width. This may provide extra space adjacent to the battery, but underneath the vehicle cabin floor. Components of the ramp assembly may be installed to utilize this space. For example, the drive motor and the drive shaft may be displaced here in the extra space. By placing the drive train components above the ramp housing, the drive train does not have to be behind the ramp platform and allows the maximum length of the ramp platform to fit under the vehicle.

In another example of this embodiment, the vehicle chassis may be supported by adjustable suspension configured to actuate the height of the vehicle chassis. The adjustable suspension may assist with use of the ramp, as lowering the vehicle chassis would result in a shallower angle of the ramp platform to traverse by a mobility passenger, while keeping the ramp platform the same length.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of the passenger side of a prior art battery electric vehicle.

FIG. 2 is a rear view of the prior art battery electric vehicle.

FIG. 3 is a cross-sectional view of a high-voltage battery assembly of the prior art battery electric vehicle of FIGS. 1-2.

FIG. 4 is a cross-sectional view of the battery electric vehicle from FIG. 1 with a first embodiment of an under-battery access device installed.

FIG. 5 is a cross-sectional view of a modified version of the battery electric vehicle from FIG. 1 comprising a height-adjustable suspension and the first embodiment of the under-battery access device.

FIG. 6 is a perspective view of a second embodiment of under-battery access device in the form of an under-battery ramp assembly.

FIG. 7 is a is a perspective view of the internal mechanisms of the under-battery ramp assembly.

FIG. 8 is a perspective view of a drive assembly of the under-battery ramp assembly.

FIG. 9 is a perspective view of a first linear guide rail assembly of the under-battery ramp assembly.

FIG. 10 is an exploded perspective view of a second linear guide rail assembly of the under-battery ramp assembly.

FIG. 11 is a perspective view of the under-battery ramp assembly with the second linear guide rail assembly in a deployed configuration.

FIG. 12 is an exploded perspective view of a lifting mechanism for the under-battery ramp assembly in a collapsed configuration.

FIG. 13 is a perspective view of the lifting mechanism coupled to a ramp platform in the collapsed configuration.

FIG. 14 is a perspective view of the lifting mechanism coupled to the ramp platform in a partially expanded configuration.

FIG. 15 is a perspective view of a stop assembly for the lifting mechanism.

FIG. 16 is a side view of the lifting mechanism for the under-battery ramp assembly in the partially deployed configuration.

FIG. 17 is a side view of the lifting mechanism for the under-battery ramp assembly in the deployed configuration.

FIG. 18 is a detail side view of the lifting mechanism for the under-battery ramp assembly in the deployed configuration.

FIG. 19 is a side view of the lifting mechanism for the under-battery ramp assembly in a partially deployed configuration.

FIG. 20 is a perspective view of a latching assembly for the under-battery ramp in a deployed configuration.

FIG. 21 is a perspective view of a cover flap assembly for the under-battery ramp in a partially deployed (partially open) configuration.

Corresponding reference numerals are used to indicate corresponding parts throughout the several views.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

### DETAILED DESCRIPTION OF THE EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure. Any alterations and further modifications in the described embodiments and any further applications of the principles of the inventions as described herein are contemplated as would normally occur to one skilled in the art. Although a limited number of embodiments are shown and described, it will be apparent to those skilled in the art that some features that are not relevant to the claimed inventions may not be shown for the sake of clarity.

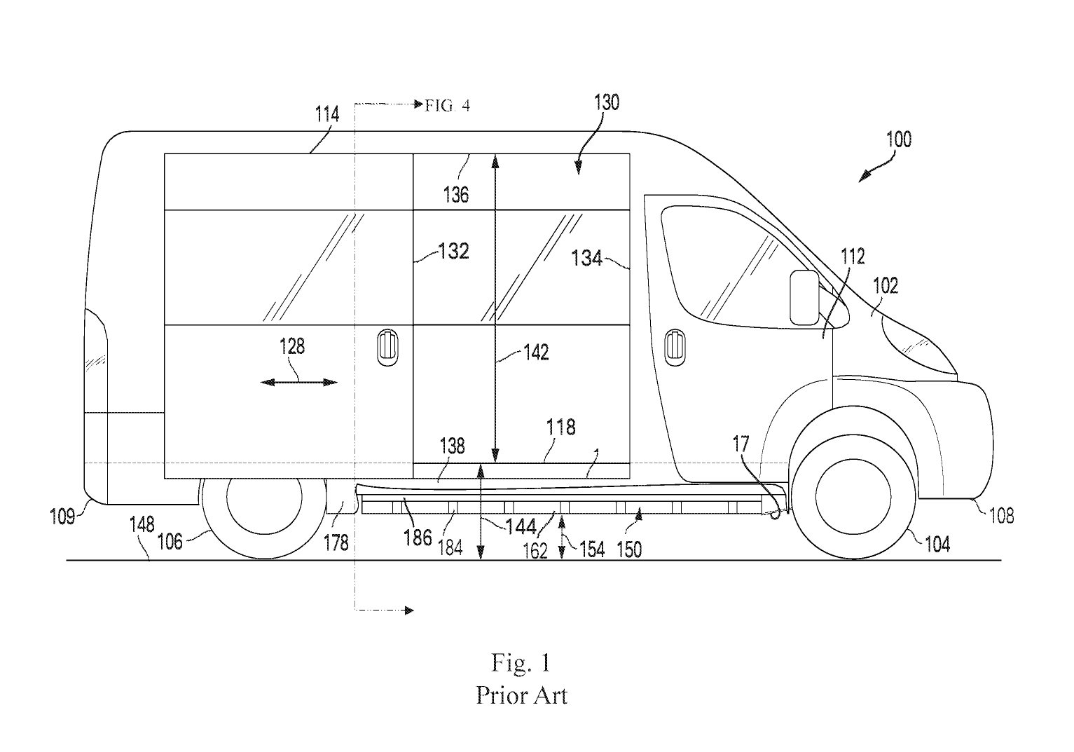

FIGS. 1-4 illustrate an example embodiment of a stock battery-electric vehicle, or BEV 100, in particular a full-size van available or soon to be available from several United States and foreign original equipment manufacturers (OEMs), such as a Ram ProMaster EV or a Ford E-Transit. The BEV 100 comprises a unibody construction. However, other vehicles contemplated within this disclosure may include a frame on body construction or other constructions. Additionally, vehicle types other than full-size vans are contemplated within this disclosure, including but not limited to minivans and SUVs.

The BEV 100 includes a vehicle body or chassis 102 operatively coupled to front wheels 104 and rear wheels 106 which support the BEV 100 as it traverses the ground. The front wheels 104 define a front axle and the rear wheels 106 define a rear axle of the BEV 100.

The BEV 100 includes a front end 108 and a rear end 109. A conventional driver’s seat and front passenger seat (not shown) are generally located towards the front end 108 of the BEV 100, whereas a plurality of rear passenger seats (not shown) are generally located towards the rear end 109 of the vehicle. More specifically, the BEV 100 includes an interior that comprises a front interior portion, where the driver’s seat and front passenger seat are located, and a rear interior portion. In some embodiments, multiple rows of rear seats are located in the rear interior portion of the BEV 100. In other embodiments, the rear interior portion of the BEV is configured to carry cargo and has less or no seats.

The BEV 100 includes a first or front passenger side door 112 located between the front wheels 104 and rear wheels 106 and providing access to a passenger for sitting in a front passenger seat (not shown) of the BEV 100 adjacent to the driver. In this position, the passenger has a clear forward view of the road when compared to sitting in a rear passenger seat of the BEV 100. Moreover, when seated, the passenger is facing in a forward direction of travel. Further, coupled to the frame 102, the BEV 100 includes a second or rear passenger side door 114 between the front and rear wheels 104, 106 and one or more rear doors 115 located at the rear end of the vehicle. It is contemplated that other vehicles within the scope of this disclosure may have a different number and/or different locations of doors.

Any one or more of the doors 112, 114, 115 may be hingedly or slidably coupled to the frame 102 of the BEV 100. In this embodiment, doors 112 and 115 are hingedly coupled while the second door 114 is slidably coupled to the frame 102. In any case, door operation may be motorized to automatically move the doors 112, 114, 115 between an open position and a closed position. See, for example, U.S. Provisional Patent Application No. 63/491,552, filed on March 22, 2023, which is incorporated herein by reference. In FIG. 1, the second door 114 is capable of being moved along a direction indicated by arrow 128 between an open position and a closed position. A user may grasp and manipulate a door handle to manually move the door 114 between the open and closed positions. In further embodiments, a key fob, vehicle switch, and/or other electrical control device (not shown) may send an electrical signal to a controller for a motor that moves the door 114 between its open and closed positions.

As the door 114 is moved to the open position, an opening 130 is created to provide access to the interior of the BEV 100. The opening 130 may be defined on the sides thereof by an edge 134 of a B-pillar and the edge 132 of the C-pillar (or alternatively an edge of the door 114). The opening 130 may additionally be defined at the top by an edge 136 adjacent to the roofline and at the bottom by edge 138 adjacent the bottom surface of the BEV 100. The usable height 142 of the vehicle opening 130 may be defined as the distance between the top edge 136 of the vehicle opening and floor surface 118 of the BEV 100. The step-in height 144 of the BEV 100 may be defined as the distance between the ground 148 and the floor surface 118, which may include a carpet. Some BEVs 100 with a large step-in height 144 may include an internal step 146 disposed between the floor surface 118 and the bottom edge 138 or an external step disposed below the edge 138 to assist entry by amble passengers.

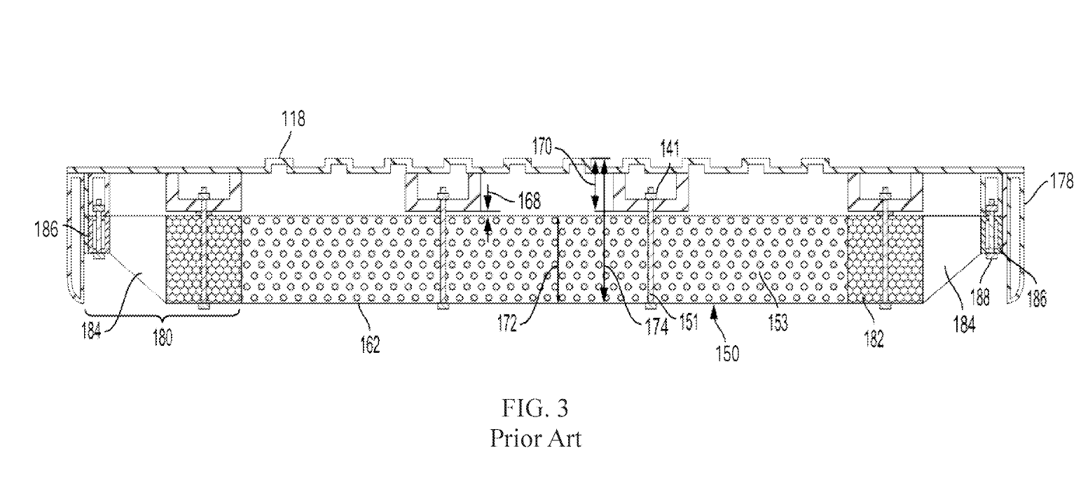

The BEV 100 includes a high capacity, high voltage (HV) battery assembly 150 (for example, in the case of the Ford E-Transit, a 68.0 kWh, 450 VDC battery) connected to the underside of the vehicle. The HV battery assembly 150 comprises a plurality of battery cells 153 disposed within a housing 162 or protective shell. With particular reference to FIG. 3, the HV battery assembly 150 is connected to the floor structure 140 of the BEV 100 using a plurality of bolts 151. The bolts 151 connect to corresponding fasteners 141 that are integrated with the floor structure 140.

The HV battery assembly 150 may include or accompany a “crush zone” or energy absorption structures to protect the battery. The “crush zone” may include a combination of one or more structural members that may be located inside and/or outside of the housing for the HV battery assembly 150. In some embodiments, the “crush zone” may be integral to the HV battery assembly 150, for example a honeycomb structure integrated into the housing. In other embodiments, the “crush zone” may be attached (permanently or removably) to the outside perimeter of HV battery assembly 150, for example, crush “cans” glued or welded to the housing of the HV battery assembly, or a cage fastened to the HV battery assembly by bolts. In yet other embodiments, the “crush zone” may be a portion of the BEV 100, for example, a rocker panel. In even further embodiments, a combination of any of the previously mentioned structures may be used.

With particular reference to FIG. 3, one example BEV 100 includes a crush zone 180 on the left and right sides of the HV battery assembly 150 to protect the HV battery cells 153 from a side impact. On each side, the crush zone 180 comprises a honeycomb core 182, a plurality of crush members or cans 184, a longitudinal beam 186, and at least a portion of the vehicle rocker panel 178. The honeycomb core 182 is disposed inside of and at the perimeter the housing of the HV battery assembly 150. The plurality of crush cans 184 are permanently affixed (e.g., welded, glued, etc.) at their proximal end to the side of the housing 162 of the HV battery assembly 150 in spaced apart relation along a longitudinal axis. The crush cans extend laterally outward therefrom and are permanently affixed (e.g., welded, glued, etc.) at their distal end to the longitudinal beam 186. The longitudinal beam 186 may be defined as a structural tube member and extends longitudinally along at least a portion of the length of the HV battery assembly 150. At least a portion of the rocker panel 178 extends downward from the floor surface 118 and is positioned on both the right and left side of the HV battery assembly 150 to protect it from side impacts. More particularly, at least a portion of the rocker panel 178 extends below the upper plane of the HV battery assembly 150 and outside of the longitudinal beam 186 and crush cans 184. To provide the crush zone 180 with additional integrity or rigidity, the longitudinal beam 186 may be secured to the rocker panel 178 via a plurality of bolts 188 or other fasteners.

In some embodiments, the front and rear edges of the HV battery assembly 150 may include similar crush zones as the left and right sides. However, because the front and rear edges of the HV battery assembly 150 are at roughly the same elevation as the front and rear axles, the front and rear axles may protect the front and rear edges of the HV battery assembly 150 from road debris. Similarly, the crush zones integrated into the vehicle chassis 102 both forward and rearward of the front and rear axles provide the HV battery assembly 150 with protection from front and rear collisions. Accordingly, the OEM BEV 100 may not need or include any external, supplemental structural members for protecting the front edge of the HV battery assembly 150. However, the BEV 100 includes a lightweight shield 176 that is not considered herein to be a structural member. The shield 176 merely prevents light weight road debris from blowing up and getting caught between the front axle and the front edge of the HV battery housing 162. The shield 176 is defined by a thin gauge plate aligned in a roughly horizontal plane at least partially below the lower plane of the HV battery housing and generally extending between the front edge of the HV battery housing 162 and the front axle.

With particular reference to FIG. 1, a ground clearance 154 may be defined as the distance between the ground 148 and a reference underside/lower surface of the vehicle (in this case the HV battery assembly 150). With particular reference to FIG. 3, in the installed position, an air gap with thickness 168 exists between the upper plane of the HV battery housing 162 and the underside of the floor structure 140. Additionally, floor structure 140 has a thickness 170, while the HV battery assembly 150 has a thickness 172. The total floor thickness 174 is therefore defined by the thickness 170 of the floor structure 140, the thickness 168 of the air gap, and the thickness 172 of the HV battery assembly 150. In one example OEM BEV 100, the floor thickness 170 may be approximately 4.4”, the air gap thickness 168 may be approximately 0.75”, and the battery thickness 172 may be approximately 7”, for a total thickness 174 of approximately 12.15”. With the OEM BEV 100 at curb weight, ground clearance 154 at approximately a mid-point of the HV battery assembly 150 may be approximately 10.0” and step-in height 144 may be 21.4”. With the BEV at GVWR (gross vehicle weight rating), ground clearance 154 may be approximately 8.3” and step-in height 144 may be 20.2”. Notably, the usable height 142 of the OEM vehicle opening 130 may be approximately 68”. For purposes this disclosure, 1” equals 2.54 cm.

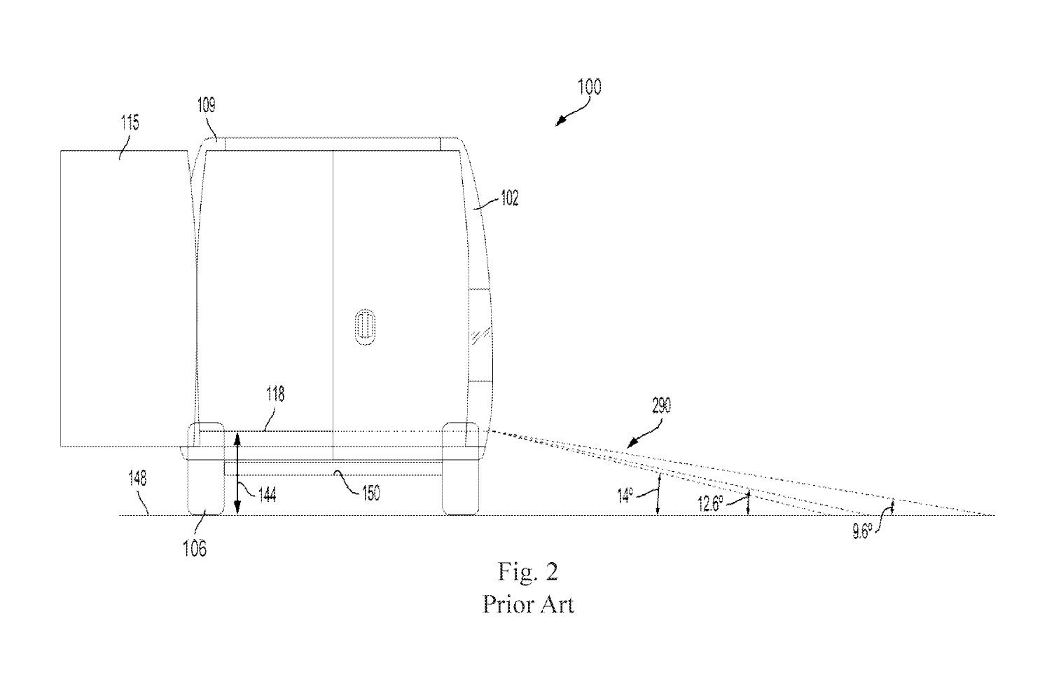

Clearly, the example OEM BEV 100 as configured is not ideal for use with a ramp 290. With reference to FIG. 2 and an OEM BEV 100 at curb weight, a ramp 290 extending between the vehicle floor surface 118 and the ground 148 at a steep angle of 14° (slightly less than ADA maximum slope of 1:4) would have a length of approximately 71.9”—approximately 6 feet long. If the ramp were angled at 12.6°, which is better but not optimal, the ramp 290 would have a length of approximately 79.8”—nearly 7 feet long. At a more optimal angle of 9.6°, which would provide a higher comfort level for a wheelchair passenger, the ramp 290 would have a length of approximately 104.3”—nearly 9 feet long. Most of these ramps 290 would be too long or not practical for use with a standard accessible parking space, which typically has a cross-hatched access aisle with a width of only 8 feet wide. Even at 14°, a six foot long ramp would provide only 2 feet of clearance with an adjacently parked vehicle—possibly making it difficult for a wheelchair passenger to comfortably maneuver on and off the ramp.

Notably, the dimensions provided above assume the use of an above-floor ramp that folds upward into a stowage position. While above-floor ramps provide cost-advantages over other style ramps, they occupy valuable space in the vehicle in the stowed position—space that could otherwise be used by occupants or cargo. While in-floor ramps solve the space problem, they create another problem in the process. An in-floor ramp must be installed above the vehicle’s conventional floor, which increases the step-in height of the vehicle and, accordingly, ramp lengths and/or angles.

While it is known in the art to lower the floors of internal combustion engine vehicles to reduce the step-in height (and thus permit a shorter ramp and/or a more optimal ramp angle), BEVs 100 have not previously been considered viable candidates for lowered-floor modification. While the step-in height 144 of the BEV 100 could be lowered simply by replacing the floor structure 140 with a thin profile replacement floor structure, such a modification will provide only minimal improvements in ramp length and/or angle. To make substantial improvements in ramp length and/or angle through a lowered floor modification, the HV battery assembly 150 must also be lowered. However, the HV battery assembly 150 is one of the most expensive subsystems of the BEV 100 and is sensitive to damage. HV battery assemblies 150 typically cannot be repaired and in many cases must be replaced if damaged. While lowering the vertical height of the HV battery assembly 150 from its original OEM position in a mobility conversion would have many ingress/egress advantages for mobility conversions and users, i.e., a lowered floor and reduced step-in height allowing more comfortable ramp angles, lowering the HV battery assembly 150 would make it more susceptible to damage from road debris and if the vehicle were to bottom out, drive over a speed bump, etc. and more susceptible to damage from side-impact collisions. Therefore, a new solution is required.

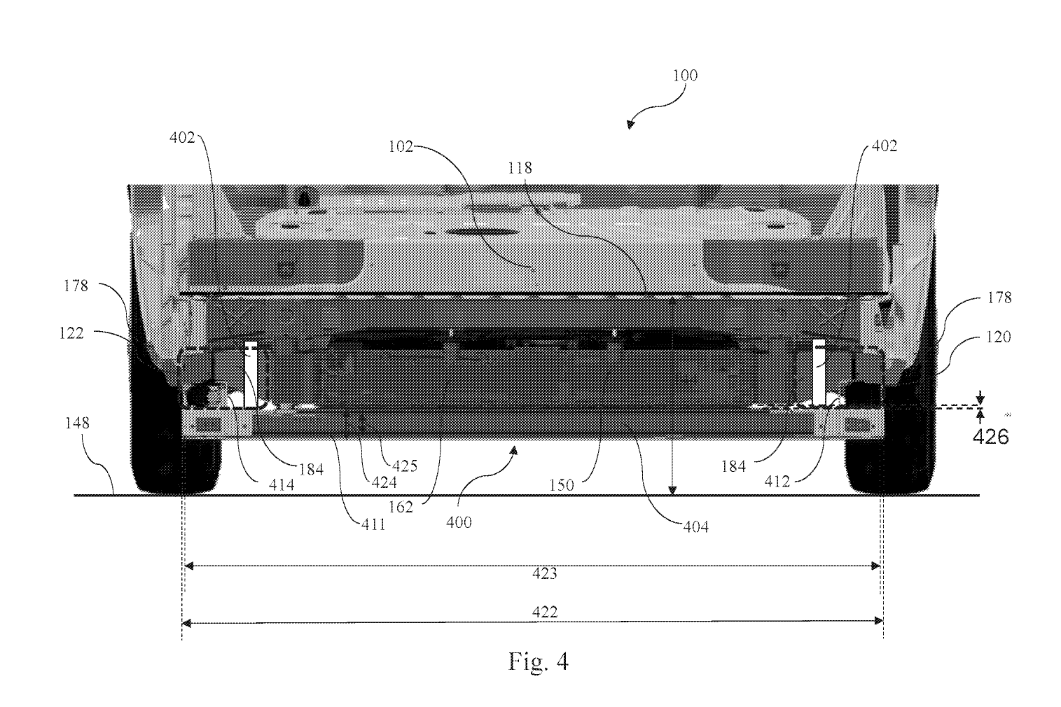

Accordingly, it is proposed herein to mount a first embodiment of a vehicle access device 400 at least partially and in some embodiments substantially both below and underneath the HV battery assembly 150, as shown in FIG. 4. The term below is used herein to mean at a lower elevation and underneath is used herein to mean directly below/beneath. Vehicle access device 400 (also referred to herein as under-battery access device 400) may take form as any type of vehicle access device, including but not limited to a ramp, a lift, and a hybrid ramp and lift (e.g., a platform that may alternatively be configured as a ramp or be operated as a lift).

The under-battery access device 400 may be mounted to the chassis 102 of the BEV 100 by one or more fasteners 402, isolated from the HV battery assembly 150 (i.e., not directly connected thereto), whereby loads imparted on the under-battery access device 400 (e.g., during a ground strike) may substantially bypass HV battery assembly 150. Additionally, in some configurations, rubber isolators (not shown) may be placed between the under-battery access device 400 and the BEV 100. The rubber isolators may be configured to absorb, buffer, or reduce impact forces transferred to the BEV 100. Fasteners 402 may comprise bolts, nuts, welds, and/or other connectors or methods for fastening the under-battery device 400 to the vehicle 100. In some embodiments, a gap 426 may be provided between the under-battery access device 400 and the underside of the HV battery assembly 150 to further isolate ground strike loads from the HV battery assembly 150. The gap 426 may assist to mitigate damage to the HV battery assembly 150 if the under-battery access device 400 bottoms out or hits road debris while the BEV 100 is operating. The gap 426 size may be optimized for the BEV 100 configuration in which the under-battery access device 400 is installed. In some embodiments, the fasteners 402 may comprise spacers that may be selected for such optimization. The gap 426 may be as large as 1/2 inch or 3/4 inch to provide adequate space between the under-battery access device 400 and the HV battery assembly 150. The larger the gap 426, however, the less clearance there is between the under-battery access device 400 and the ground 148. Alternatively, the gap 426 may be a smaller value such as 5/16 inch - 3/8 inch corresponding to a nominal thickness of a foam, or other force-absorbing material, that may be inserted within the gap 146. A narrower gap 146 may be desirable to provide greater ride height clearance between the under-battery access device 400 and the ground.

The under-battery access device 400 may comprise a housing 410, which may be defined by an assembly of frame members and/or walls/panels that provide structural rigidity and protection from ground strikes and road debris and protect internal components from the elements, including water and other corrosive elements like road salt, and a platform 404. As shown, the housing 410 is defined at least by first portion 411 having a length 422 (oriented in the vehicle lateral direction) and a height 424. The first portion 411 may generally take the form of a rectangular prism or cuboid. In a stored position, the platform 404 is contained within the first portion 411 and has a length 423 and a height 425 that are slightly less than or within a fraction of an inch of the length 422 and height 425 of the first portion 411. In some embodiments, length 423 is ~1.5” less than the length 422. In other embodiments, height 425 is 0.75” less than the height 424. In one embodiment, the length 422 of the first portion 411 is approximately 71.5”, the height 424 of the first portion 411 is approximately 3”, the length 423 of the platform 404 is approximately 70”, and the height 425 of the platform 404 is approximately 2.25”.

In some embodiments, the housing 410 may additionally be defined by one or more additional portions, such as second portion 412 and third portion 414. As shown, the second and/or third portion 412, 414 may be positioned above the first portion 411 wherein, when the under-battery access device 400 is installed on the vehicle 100, the second and third portions 412, 414 are located at least partially within what is referred to herein as “free spaces” or “bonus spaces” 120, 122. More particularly, the second portion 412 is disposed above the first portion 411 at a rear end of the ramp assembly 400 (corresponding to the street side of the vehicle, e.g., left side of the vehicle in the United States), while the third portion 414 is disposed above the first portion at a front end of the ramp assembly 400 (corresponding to the curb side of the vehicle 100, e.g., right side of the vehicle in the United States). In one embodiment, free spaces 120, 122 may be defined as the volumes positioned laterally to the outside (right and left with reference to the vehicle 100) of the housing 162 of HV battery assembly 150 and laterally to the inside of the vehicle’s 100 left and right side rocker panels 178. More particularly, free space 120 may be defined as the volume located between a first vertical plane generally aligned with the right side of the housing 162 and a second vertical plane generally aligned with the right rocker panel 178, between a third vertical plane generally aligned with the front side of the housing 162 and a fourth vertical plane generally aligned with the rear side of the housing 162, and between a first horizontal plane generally aligned with the top surface of the housing 162 and a second horizontal plane generally aligned with a bottom surface of the housing 162. Similarly, free space 122 may be defined as the volume located between a first vertical plane generally aligned with the left side of the housing 162 and a second vertical plane generally aligned with the left rocker panel 178, between a third vertical plane generally aligned with the front side of the housing 162 and a fourth vertical plane generally aligned with the rear side of the housing 162, and between a first horizontal plane generally aligned with the top surface of the housing 162 and a second horizontal plane generally aligned with a bottom surface of the housing 162.

A distance 420 between the first and second portions 412, 414 of the housing 410 exceeds the width of the housing 162 of the battery 150, whereby a gap in the lateral direction may exist between the first and second portions 412, 414 and the housing 162 of the battery to reduce the chance that forces from a side impact will be transferred to the battery 150. In some embodiments, the distance 420 may correspond to or be slightly larger than the width of the housing 162.

To the extent that the second and or third portions 412, 414 of the housing 410 may overlap with vehicle components inside of the free spaces 120, 122, such as the crush zone 180 and/or crush cans 182, they may be modified or removed. For instance, in some configurations, the first and second portions 412, 414 of the housing 410 may run along substantially the entire width of the access device 400 (the width running in the direction from the front to back of the vehicle). In such cases, the first and second portions 412, 414 may interfere with components located in the free spaces 120, 122 and modifications must be made. To the extent necessary, the second and/or third portions 412, 414 of the housing 410 may be structurally reinforced to provide the same or better side impact protection as the removed vehicle components (e.g., the vehicle still meets applicable standards and regulations, such as FMVSS 214 and/or 305). In other embodiments, the crush zone 180 structures may be replaced by a modified (e.g., lower profile) solution that accommodates the second and/or third portions 412, 414. In yet other embodiments, the second and third portions 412, 414 of the housing 410 may be discontinuous along the width of the access device 400 whereby they will fit within or around other vehicle components in the free spaces 120, 122.

In some embodiments, the under-battery access device 400 may be fully or at least partially (e.g., in combination with fasteners 402) secured to the vehicle 100 by the second and third portions 412, 414 of the housing 410, whereby any loads imparted on the access device 400 (e.g., ground strikes) will substantially bypass the battery 150.

Mechanical or electrical components such as, but no limited to, motors, gearing, drive assemblies, control boards, electrical sensors, and opening cover flaps may be oriented to fit into or mount onto one or both of the first or second portions 412, 414. Locating such components at least partially within in the free space 400 allows the platform 404 to be as long as possible (i.e., utilize nearly the entire length 422 from the vehicle left side to the vehicle right side of the first portion 411 of the housing 410) and also allows the first portion 411 of the housing 410 that sits below the HV battery assembly 150 to be as thin as possible (thereby improving ground clearance and breakover angle). If both of the first and second portions 412, 414 are present, the housing 410 may substantially define a U-shape. If only one of the first and second portions 412, 414 are present, the housing 410 may substantially define an L-shape.

Positioned at least substantially underneath the HV battery assembly 150 and possibly also within the free spaces 420, 422 to the left and right of the housing 162 of the HV battery assembly 150, the vehicle access device 400 will not occupy valuable floor space in a stowed position like an above-floor ramp or a traditional lift, will not reduce headroom inside of the vehicle and/or will not increase the step-in height 144 like an in-floor ramp, can serve as a sacrificial (and/or reinforced) structure to protect the HV battery assembly 150 from ground strikes or road debris, and may eliminate a need to lower the HV-battery assembly 150 and/or reduce the thickness 170 of the floor structure 140.

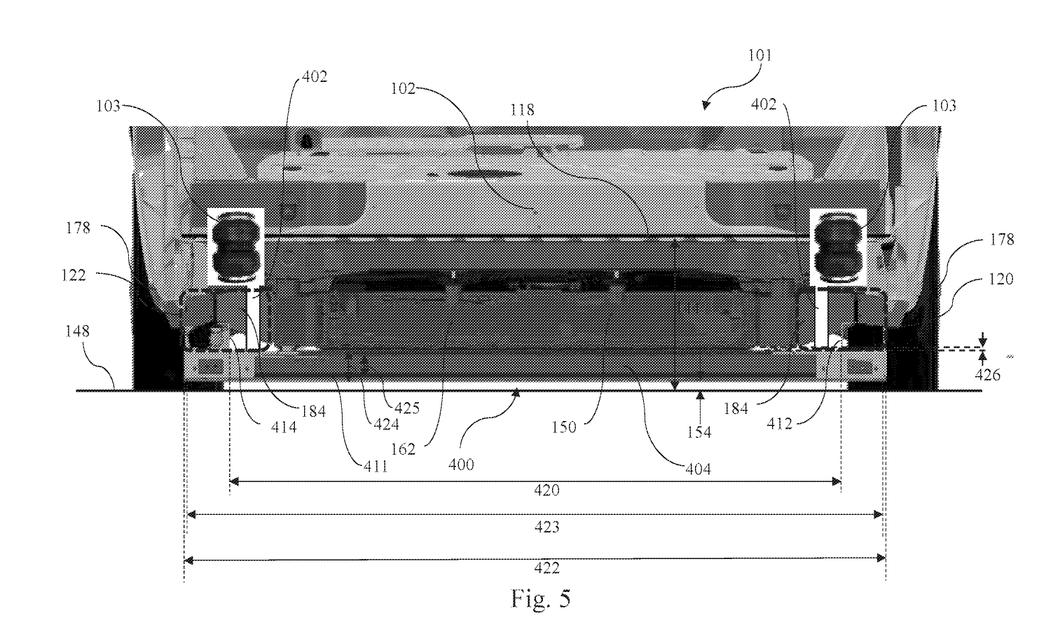

Notwithstanding, it is contemplated that the under-battery access device 400 may be used in a BEV that has been modified to include a lowered floor, a reduced-thickness floor, a lowered battery, and/or a height-adjustable suspension. See, for instance, the modifications described and claimed in U.S. Patent Application No. 63/591,642, filed on 19 October 2023. See also FIG. 5, where the under-battery access device 400 is shown coupled to the underside of a modified BEV 101 that includes a height-adjustable suspension 103. The modified BEV 101 may be substantially the same as the OEM BEV 100, except that the suspension at any one or more wheels of the OEM BEV 100 could be replaced or supplemented with an air suspension, airbag, hydraulic or pneumatic bodylift cylinders, or other kneeling/lifting device 103 whereby the elevation of the modified BEV 101 chassis 102 can be raised and lowered on command, for example by operation of an on-vehicle air compressor or hydraulic pumps and release valve in fluid communication therewith. In one embodiment, the height-adjustable suspension 103 may be actively controlled. In another embodiment, the height-adjustable suspension 103 is configured to move the modified BEV 101 chassis 102 between a kneeled (or lowered) position and a lifted (or raised) position, the lifted position being at a higher elevation than the kneeled position. In some embodiments, the difference in elevation of the BEV 101 chassis between the kneeled and lifted positions can be approximately 3”, 4”, 5”, 6” or more. In the kneeled position, as shown in FIG. 5, the floor 118 of the modified BEV 101 is closer to the ground 148 which reduces the step-in height 144 as compared to the same of the BEV 100 shown in FIG. 4 and, in cases where the vehicle access device 400 is a ramp, allows a more palatable ramp angle and length. In some embodiments, as shown in FIG. 5, the vehicle access device 400 can be touching or nearly touching (in some embodiments, ground clearance 154 may be approximately 1”; in other embodiments ground clearance 154 may be 1” plus or minus ¼”, 1” plus or minus ½”, approximately 1.5”, or approximately 2”) the ground 148 when the modified BEV 101 is in the kneeled position. In the lifted position, the ground clearance for the vehicle access device 400 is increased to reduce the possibility of ground contact or damage from road debris while the modified BEV 101 is driving. The use of some types of kneeling/lifting devices 296, such as airbags or other kneeling devices, allows the modified BEV 101 chassis 102 to stay at a relatively constant elevation in the lifted position regardless of the loading condition. In that regard, the elevation of the HV battery assembly 150 at the lifted position may be roughly the same or greater than the elevation of the modified BEV 101 is at curb weight or GVWR. Maintaining the ground clearance of the HV battery assembly 150 in the modified BEV 101 equal to or above the minimum ground clearance deemed acceptable by the OEM (i.e., the ground clearance of OEM BEV 100 at GVWR) should preserve the OEM warranty over the HV battery assembly 150 for the end user.

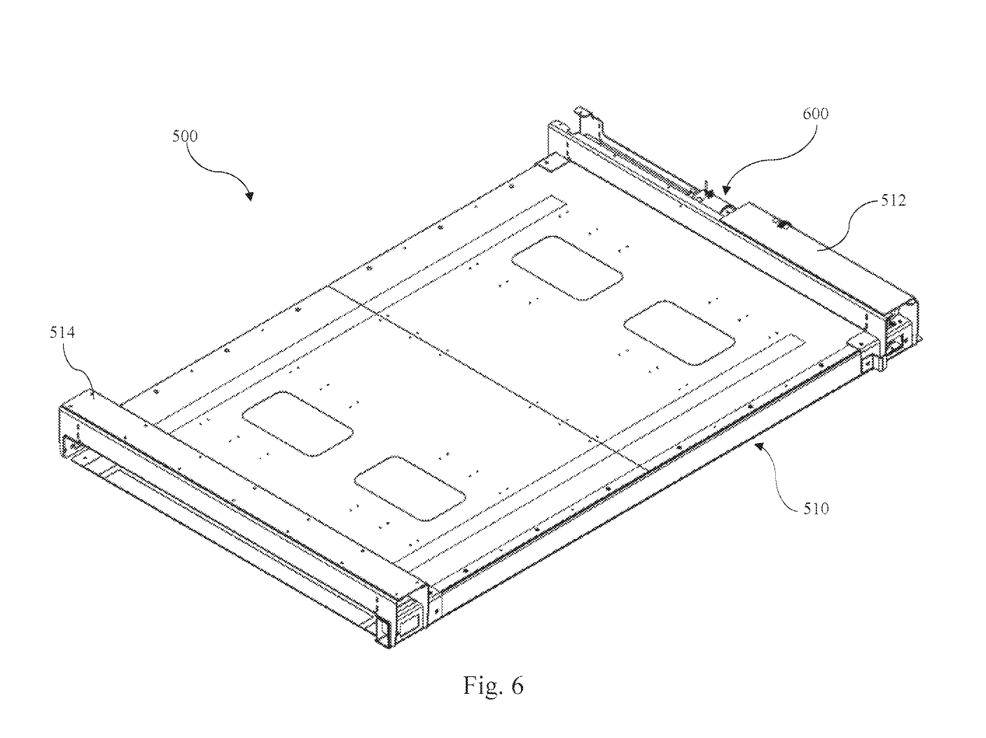

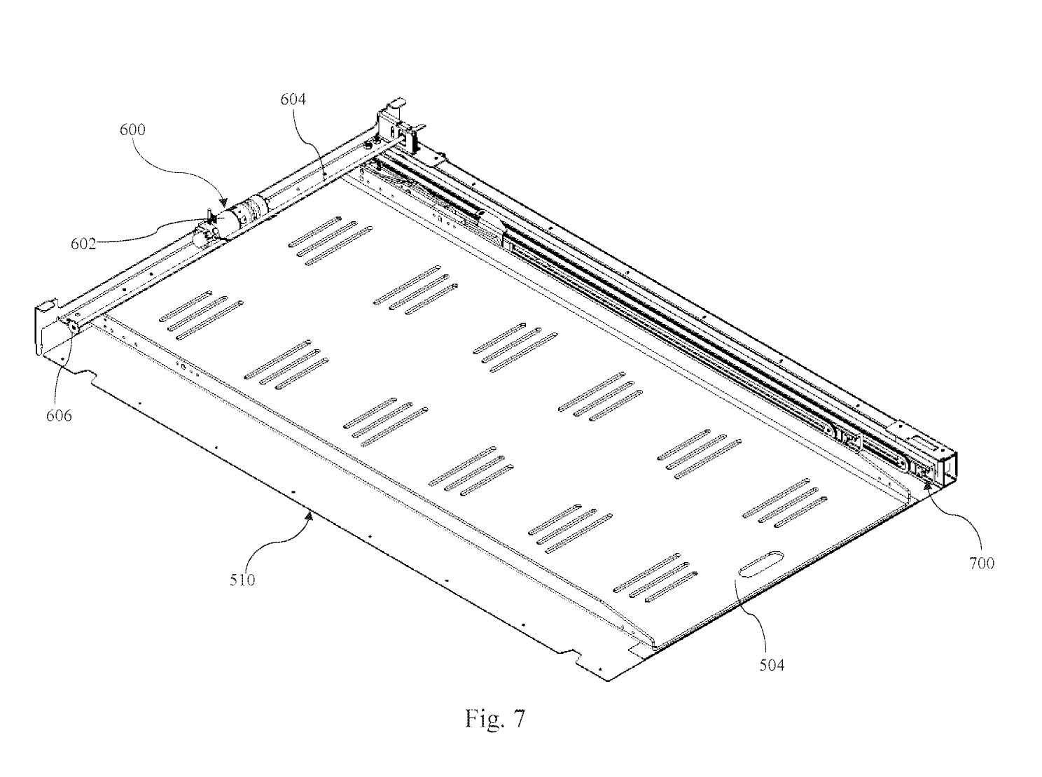

FIGS. 6-21 illustrate a second embodiment of an under-battery access device in the form of an under-battery ramp assembly 500. The under-battery ramp assembly 500 of the second embodiment may be configured, dimensioned, and installed on a vehicle in largely the same way as the first embodiment, with optional variations described below. In that regard and as shown in FIG. 6, the housing 510 is defined by a first portion 511, a second portion 512, and a third portion 514. The first portion 511 generally takes the form of a rectangular prism or cuboid. In a stored position, a platform 504 (shown in FIG. 7) is contained within the first portion 511 and has a length 523 and a height 525 that are slightly less than or within a fraction of an inch of the length 522 and height 525 of the first portion 511, as described above for the first embodiment. The second and third portions 512, 514 are positioned above the first portion 511 wherein, when the ramp assembly 500 is installed on the vehicle 100, they may be at least partially located within the free spaces 120, 122 of the vehicle 100. More particularly, the second portion 512 is disposed above the first portion 511 at a rear end of the ramp assembly 500 (corresponding to the street side of the vehicle, e.g., left side of the vehicle in the United States), while the third portion 514 is disposed above the first portion at a front end of the ramp assembly 500 (corresponding to the curb side of the vehicle 100, e.g., right side of the vehicle in the United States).

FIG. 7 illustrates a perspective view of the under-battery ramp assembly 500 with various panels of the housing 510 hidden for visibility of the subsystems. As shown, the under-battery ramp assembly 500 may have a drive assembly 600 configured to drive the ramp platform 504 of the under-battery access device 500 between a stowed position and a deployed position. The drive assembly 600 may be positioned substantially above the first portion 511 of the housing 510 in the second portion 512. In that regard, the drive assembly 600 is located substantially above a ramp platform 504, allowing the ramp platform 504 to have a length that is nearly as long as the housing 510. Further enabling a longer ramp platform 504, and as discussed in more detail below, linearly deployment mechanisms that work in cooperation with the drive assembly 600 to move the ramp platform 504 are located substantially to the sides of the ramp platform 504. Considered in combination, locating the drive assembly 600 above the ramp platform 504 and the linear deployment mechanisms to the side substantially removes any components from behind the ramp platform 504, which allows the ramp platform 504 length to be maximized within the housing 510, which assists with the ramp angle as previously discussed.

FIG. 7 depicts the ramp platform 504 in the stowed position inside of housing 510. Drive assembly 600 may include a drive motor 602 operably coupled with a drive shaft 604. Operation of the drive motor 602 in a first direction rotates the drive shaft 604 in a first direction, while operation of the drive motor 602 in a second direction rotates the drive shaft 604 in a second direction. The drive shaft 604 may extend from one end of the first portion 512 of the housing to the other end, along the entire width of the ramp assembly 500. A drive sprocket 606 may be coupled at each end of drive shaft 604 to rotate with the drive shaft. Each drive sprocket is operably coupled with a ramp deployment mechanism located on opposide sides of the ramp platform 504 to transfer power from the drive shaft 604 to the ramp deployment mechanisms. The ramp deployment mechanisms may be mirror images of each other. Accordingly, only the right-side deployment mechanism is described herein to provide clarity. For the avoidance of doubt, it is contemplated that some embodiments of the ramp assembly 500 may only require one ramp deployment mechanism on one side of the ramp platform 504.

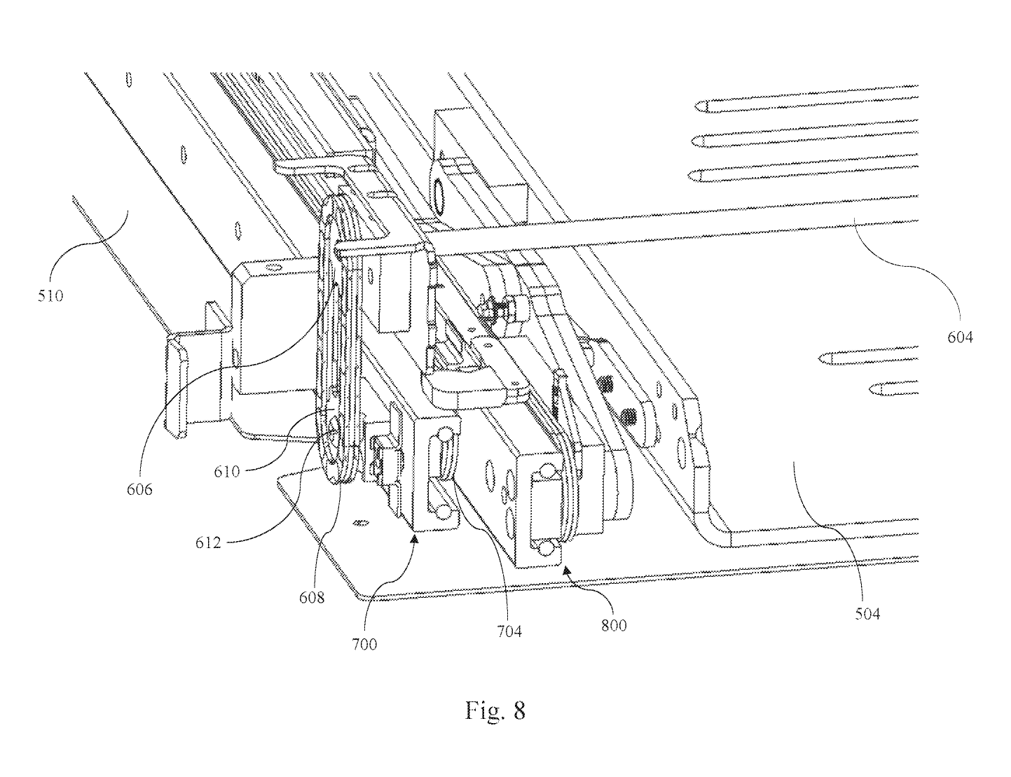

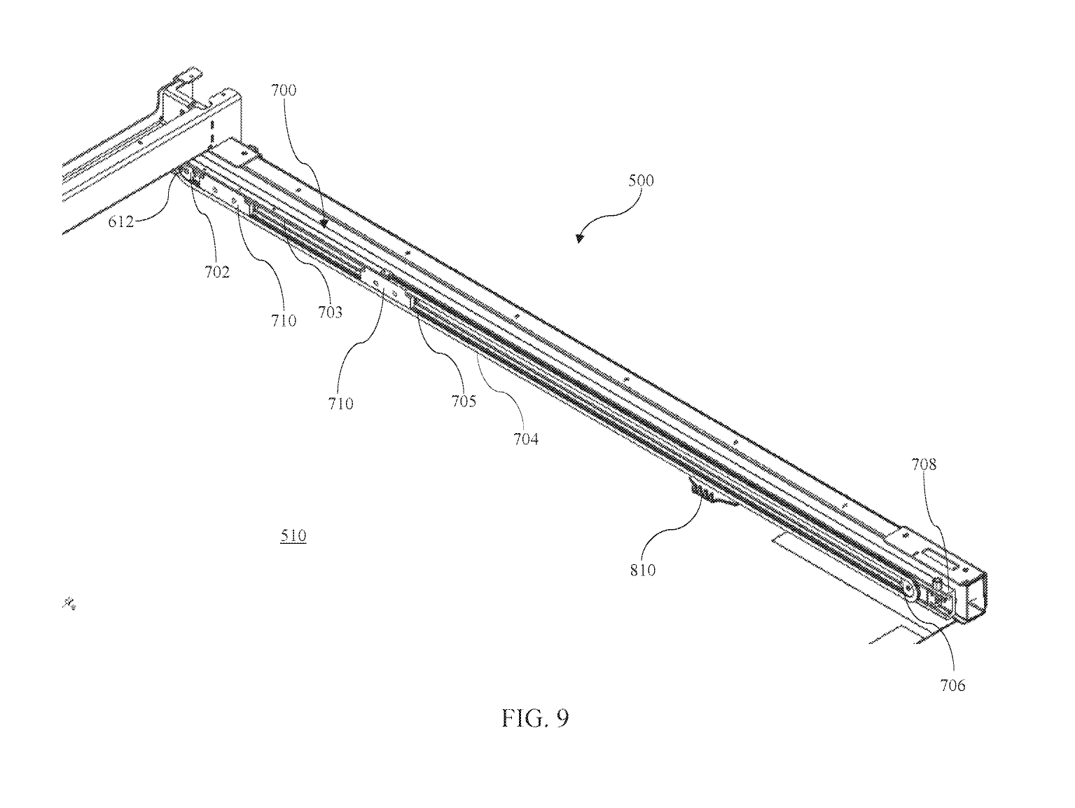

Drive sprocket 606 may transmit power from the drive sprocket 604 via a drive chain 608 to a second drive sprocket 610, as shown in FIG. 8, a perspective view from the rear of the under-battery access device 500. As shown, drive chain 608 is operably coupled between drive sprocket 604 and second drive sprocket 610. The second drive sprocket 610 may be operably coupled to a first end of a drive shaft 612, where drive sprocket 610 and drive shaft 612 are fixed and rotate together. A first drive sprocket 702 of the first linear guide rail assembly 700 may be operably coupled to an opposite end of the drive shaft 612, as shown in FIG. 9, where first drive sprocket 702 and drive shaft 612 are fixed and rotate together. In FIG. 9, the ramp platform 504 and various other components are hidden to demonstrate the function of the first linear guide rail assembly 700.

The first linear guide rail assembly 700 comprises a first linear guide rail 708 fixedly mounted to the housing 510. The first linear guide rail 708 has a first end, or stow end, approximate the drive assembly 600 and a second (opposite) end, or deploy end. The first drive sprocket 702 may be positioned in a fixed position at or near the first end of the first linear guide rail 708 and configured to transmit power from the drive assembly 600 to a first chain 704 wrapped around a first idle sprocket 706 positioned in a fixed position at or near the second end of the first linear guide rail 708. The first chain 704 may be fixedly coupled to one or more guide blocks 710. End links of the first chain 704 may be coupled via fasteners to the one or more guide blocks 710. As illustrated, when two guide blocks 710 are utilized, the first chain 704 may be broken up into two subsections to complete the loop around the sprockets 702, 706 and fasten to the two guide blocks 710. A first subsection 703 extends between the two guide blocks 710, while a second subsection 705 extends from the right side of the right guide block 710 (as seen in FIG. 9) around sprocket 706 at the second end of the linear guide rail 708, back to and around sprocket 712 at the first end of the linear guide rail 708, and then to the left side of the left guide block 710.

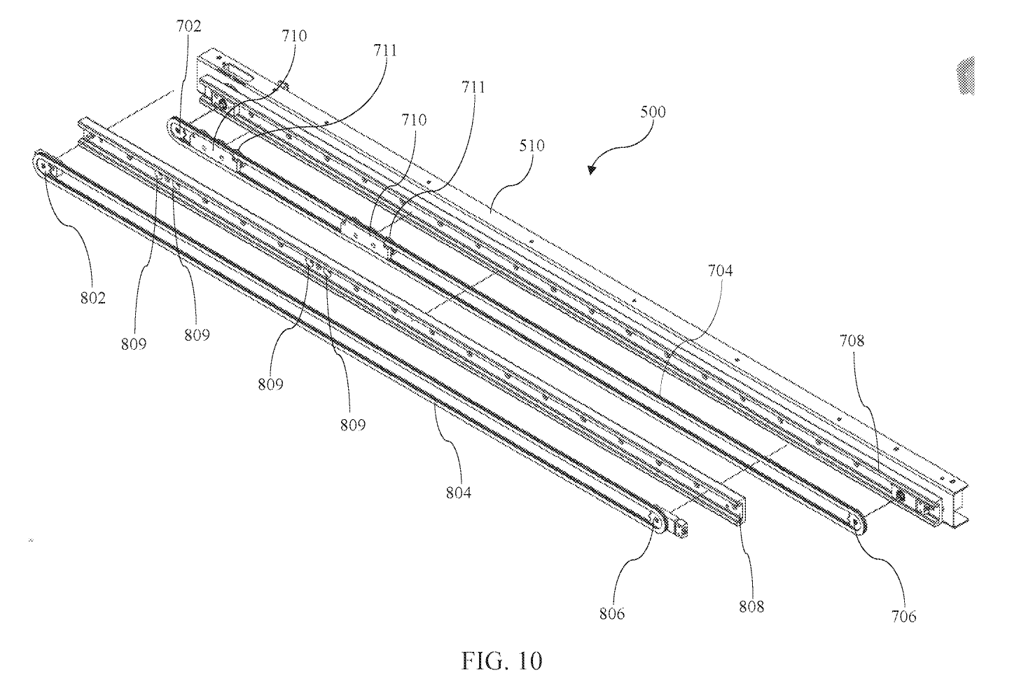

FIG. 10 illustrates an exploded view of the assembly of the first linear guide rail assembly 700 to a second linear guide rail assembly 800. The second linear guide rail assembly 800 comprises a second linear guide rail 808. The second linear guide rail 808 has one or more apertures configured to receive fasteners for fixedly coupling the second linear guide rail 808 to the guide blocks 710 of the first linear guide rail assembly 700. The guide blocks 710 may include through holes, tapped holes, weld nuts, or any other fastening provisions such that a second linear guide rail assembly 800 may be fixedly coupled to the guide blocks 710. The guide blocks 710 may include a plurality of rollers 711 configured to linearly traverse and be retained within the guide rail 708. The cross-sectional profile of guide rails 708, 808 may be substantially C-shaped such as PBC Linear part number RR18CR. Other guide rail cross-sectional designs and accompanying roller configurations to accomplish linear guidance are contemplated. Transmission of the power from the motor 502 to rotate drive shaft 604, sprocket 606, chain 608, sprocket 610, shaft 612, sprocket 702, and chain 704 results in the guide blocks 710 traveling along linear guide rail 708 from the first end to the second end, or vice versa. In other words, rotation of the motor 602 in the first direction causes the guide blocks 710 to move away from the first end and toward the second end of the guide rail 708, and rotation of the motor 602 in the second direction causes the guide blocks to move away from the second end and toward the first end of the guide rail 708.

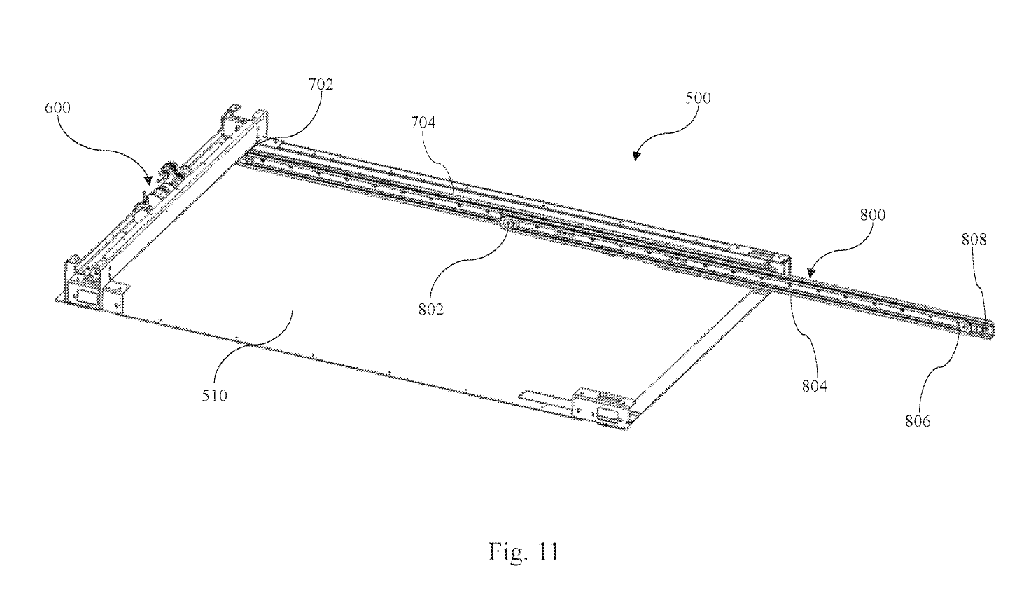

A second idle sprocket 802 may be coupled to the second linear guide rail 808 in a fixed position at or near a first end and a third idle sprocket 806 may be coupled to the second linear guide rail 808 in a fixed position at or near a second end of the second linear guide rail 808. A second chain 804 may be looped around second and third idle sprockets 802, 806. The second linear guide rail 808 may be fixedly coupled to the guide blocks 710 such that when the first chain 704 rotates, the guide blocks 710 move the second linear guide rail assembly 800 from a stowed position in which the second linear guide rail assembly 800 is substantially within the housing 510, to a deployed position in which the second linear guide rail assembly 800 is at least partially extended out of the housing 510. The second linear guide rail assembly 800 is illustrated in the deployed position in FIG. 11.

Neither of the second and third idle sprockets 802, 806 are functionally coupled to the first chain 704, or any other components in the drive assembly 600 such that the second and third idle sprockets 802, 806 transmit power. Instead, an anchor 810, as shown in FIG. 9 is fixedly coupled to the housing 510 and configured to fix a point on the second chain 804 to the housing 510. In the illustrative embodiment, the anchor 810 includes a plurality of “fingers” configured to engage with one or more chain links, but other fastening provisions for anchoring a chain are contemplated. By fixing a point on the second chain 804 to a static anchor 810, as the first chain 704 rotates to move the guide blocks 710 and linearly transpose the second linear guide rail 808, the anchor 810 fixes a point on the second chain 804 (in this case the bottom side of the chain loop) such that movement of the second linear guide assembly 800 relative to the housing 510 causes the second chain 804 to rotate relative to the second guide rail 808. Anchoring the second chain 804 in this manner causes the top of the second chain 804 loop to move twice as fast as the second guide rail 808 relative to the housing 510. When the motor 602 rotates in the first direction, the top of the second chain 804 loop moves towards the second end of the second guide rail 808, and when the motor 602 rotates in the second direction, the top of the second chain 804 loop moves towards the first end of the second guide rail 808.

It should be considered that a third linear guide assembly may be coupled to the second linear guide rail assembly 800 in the same way the second linear guide rail assembly 800 is coupled to the first linear guide rail assembly 700 to have a further multiplying effect. In this configuration, a third chain on the third linear guide rail assembly may be anchored to a static point. The under-battery ramp assembly 500 may include any number of linear guide rail assemblies required for an adequate deployed position.

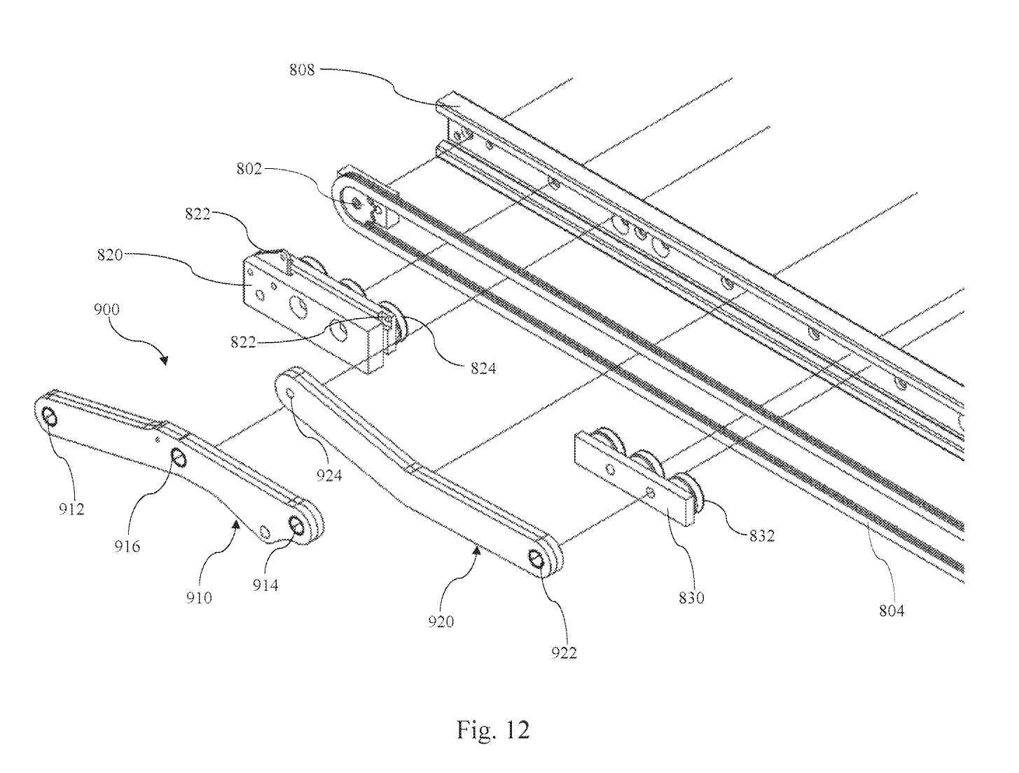

FIG. 12 illustrates an exploded view of the assembly of a lifting mechanism 900 to the second linear guide rail assembly 800. A first guide block 820 may include a plurality of rollers 824 configured to linearly traverse and be retained within the second guide rail 808. The first guide block 820 may include chain mounting points 822 configured to fixedly couple to links of the second chain 804 at the top of the second chain 804 loop. The first guide block 820 is fixedly integrated with the loop of the second chain 804 such that rotation of the second chain 804 causes the first guide block 820 to linearly travel along the second linear guide rail 808. It should be appreciated that the compiling of the motion of the first and second chains 704, 804 results in a movement of the first guide block 820 twice the speed compared to the speed of guide blocks 710 relative to the housing 510. It should also be appreciated that rotation of motor 602 in the first direction causes the first guide block 820 to move toward the second end of the guide rail 808 and rotation of the motor 602 in the second direction causes the first guide block to move toward the first end of the guide rail 808.

A second linear guide block 830 may include a plurality of rollers 832 configured to linearly traverse and be retained within the second guide rail 808. The second linear guide block 830 may have substantially a thin profile (small in height) such that it is not coupled to the second chain 804 and is thin enough to linearly travel along the second linear guide rail 808 without contacting the second chain 804. In other words, it fits inside of the second chain 804 loop between the top half and bottom half of the second chain 804 loop. The lifting mechanism 900 may be coupled to the first and second guide blocks 820, 830.

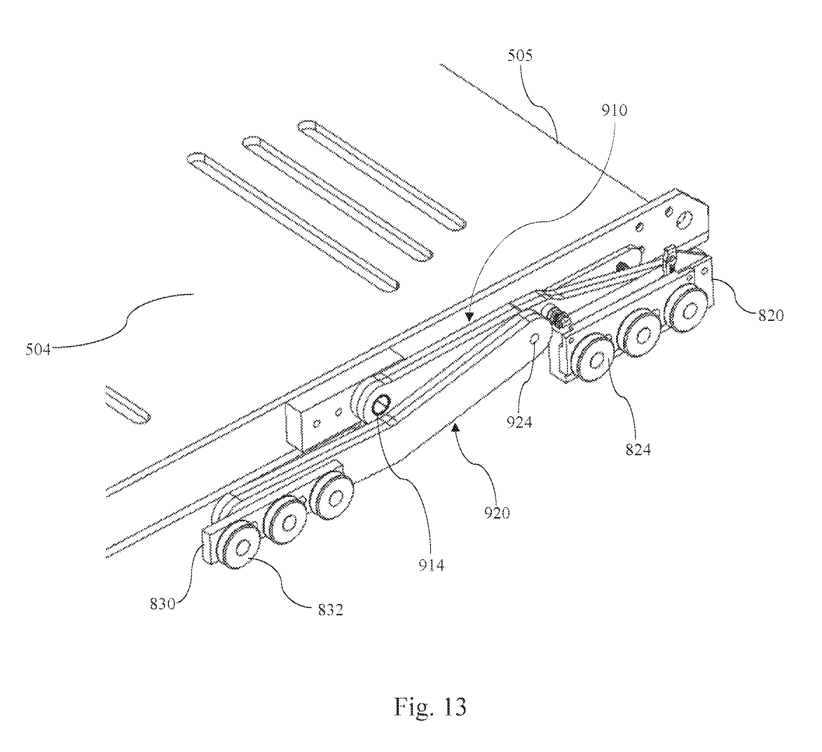

The lifting mechanism 900 may include a first lifting arm 910 and a second lifting arm 920. The first lifting arm 910 may be rotatably coupled to the first guide block 820 at a first end 912 of the first lifting arm 910. The second lifting arm 920 may be rotatably coupled to the second guide block 830 at a first end 922 of the second lifting arm 920. A second end 924 of the second lifting arm 920 may be rotatably coupled to a midpoint 916 of the first lifting arm 910. In some embodiments, the midpoint 916 may be substantially centered between the first end 912 and a second end 914 of the first lifting arm 910, but in other embodiments the midpoint 916 may be located anywhere between to the first and second ends 914, 916 of lifting arm 910 to optimize the lifting mechanism 900. The second end 914 of the first lifting arm 910 may be rotatably coupled to the ramp platform 504, as illustrated in FIG. 13. The second guide block 830 is not fixedly coupled to the second chain 804 and is free to move independently of the second chain 804. When the second chain 804 is rotating to translate the first guide block 820, the first guide block 820 will push to the second guide block 830 via the interconnection between the first and second guide blocks 820,830 provided by the first and second lifting arms 910, 920. The weight of the ramp platform 504 may keep the first and second lifting arms 910, 920 in the collapsed position shown in FIG. 13 such that the lifting arms 910, 920 do not contact any part of the housing 510 before the deployed position.

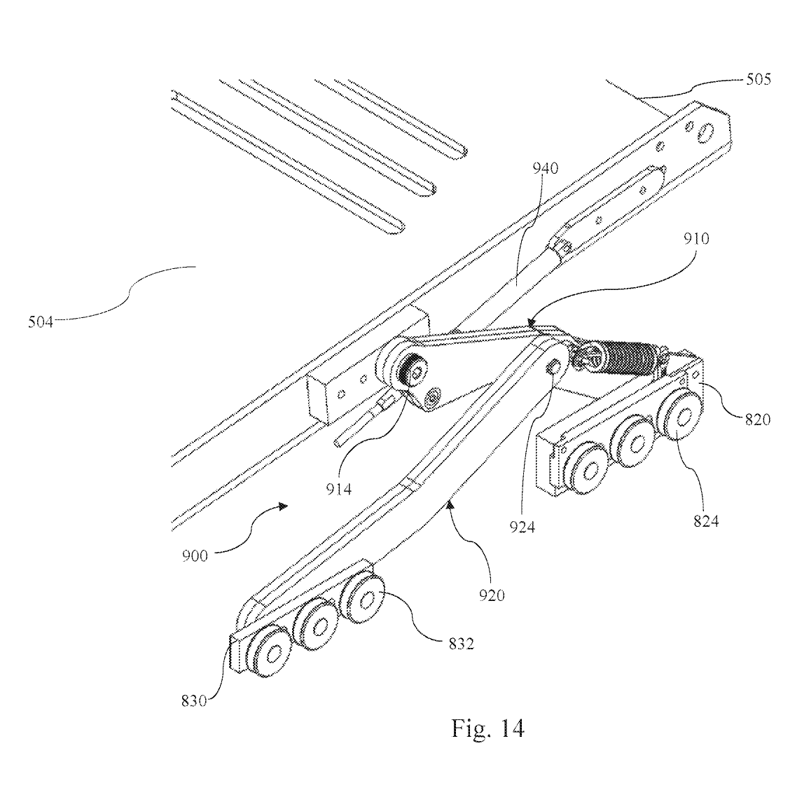

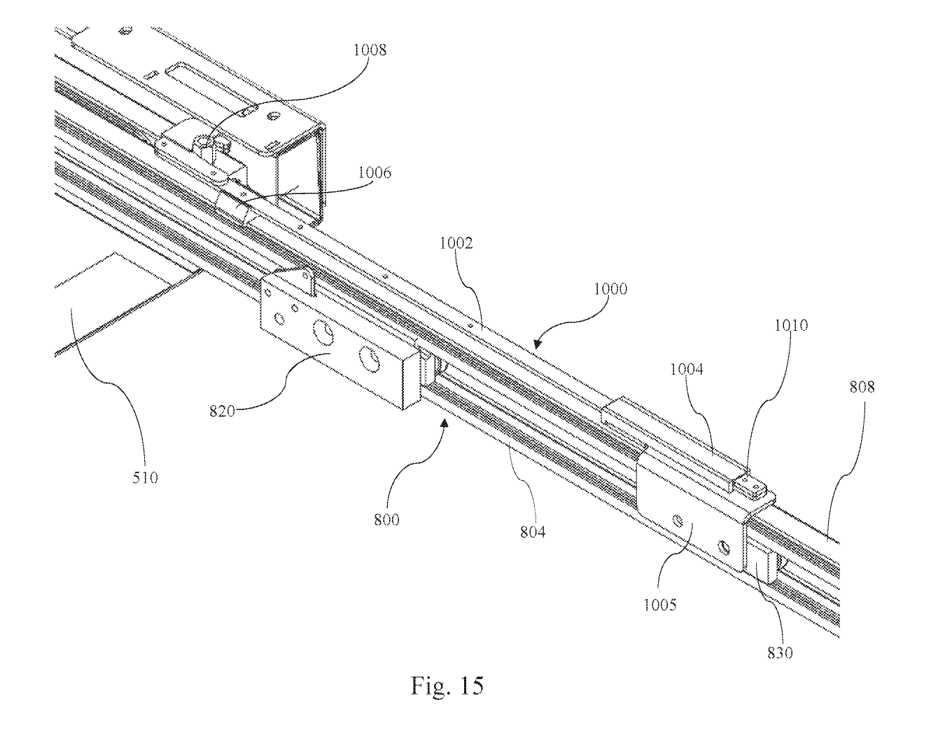

FIG. 14 illustrates the lifting mechanism 900 in a partially expanded or raised position in which an inboard end 505 of the ramp platform 504 is raised in a vertical direction. The first and second lifting arms 910, 920 act as a scissor mechanism in which as the first and second guide blocks 820, 830 move closer together, the first and second lifting arms 910, 920 pivotably rotate about the first and second guide blocks 820, 830 and expand to raise the inboard end 505 of the ramp platform 504. The first and second guide blocks 820, 830 are moved closer together via a stop assembly 1000, illustrated in FIG. 15.

FIG. 15 illustrates the second linear guide rail assembly 800 near the end of its stroke from the stowed position to the deployed position as in FIG. 11, with detail on the stop assembly 1000. The stop assembly may comprise a hook 1002. The hook 1002 may be fully retained in a slider 1004 such that the hook can only travel in the linear axis along the length of the guide rail 808, and at least partially retained by a channel 1006. The slider 1004 and channel 1006 be constructed with low-friction material such as UHMW to allow smooth sliding of the hook 1002 through the slider 1004 and the channel 1006. The slider may be fixedly coupled to a bracket 1005 which fixedly couples to the second guide block 830. The bracket may be temporarily fixed via fasteners or permanently fixed via welding, or the bracket 1005 may be an extension of the second guide block 830. When the second guide block 830 reaches the desired deployed position, the hook 1002 may engage with a peg 1008 fixedly coupled to the housing 510. As illustrated, the peg 1008 may be a fastener such as a bolt or a nut that is fixedly coupled to the housing 510. Alternatively, the peg 1008 may be a permanent extension of the housing 510, however the temporary fixing of a fastener may be desired such that the position of the peg 1008 may adjusted relative to the housing 510. As previously described, the second chain 804 rotates to linearly slide the first guide block 820 along the second guide rail 808. The first lifting arm 910 rotatably fixed to the first guide block 820 transfers the force inducing movement to the second lifting arm 920 which causes the second guide block 830 to travel along with the first guide block 820. When the hook 1002 engages with the peg 1008, it restricts the hook 1002 from traveling any further. The hook 1002 may have one or more protrusions 1010 configured to be larger than the gap in slider 1004. The protrusion 1010 prevent the hook 1002 from completely entering the slider 1004. Instead, when the protrusion 1010 contacts the outside of the slider 1004, the hook 1002 prevents the slider 1004, and therefore the second guide block 830, from traveling further. As discussed, the second guide block 830 is narrower and can move independently from the second chain 804 without contact. Therefore, the first guide block 820 may continue to move along the second linear guide rail 808 while the second linear guide block 830 is prevented from further movement relative to the guide rail 808 by the stop 1000.

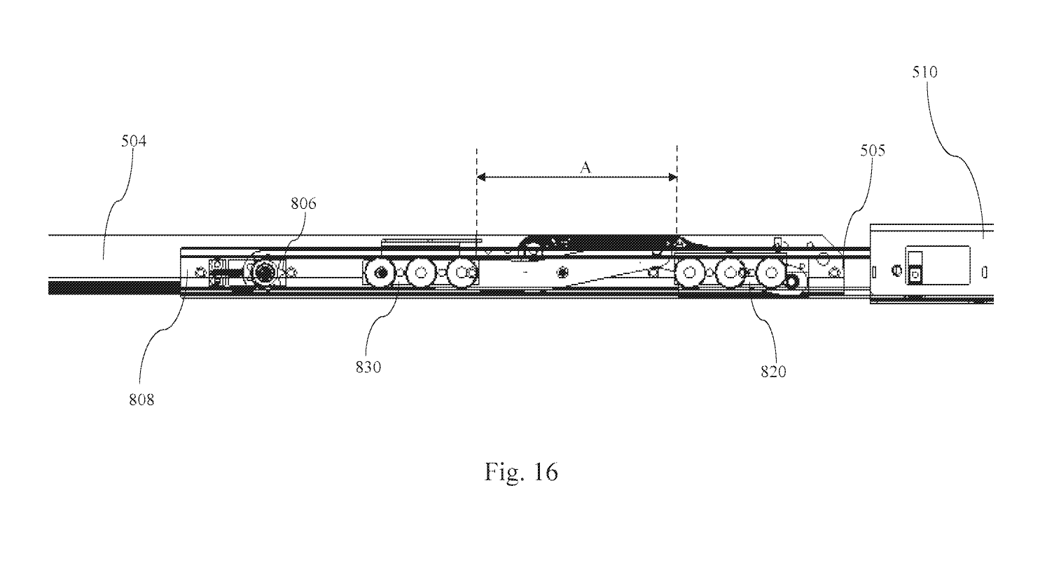

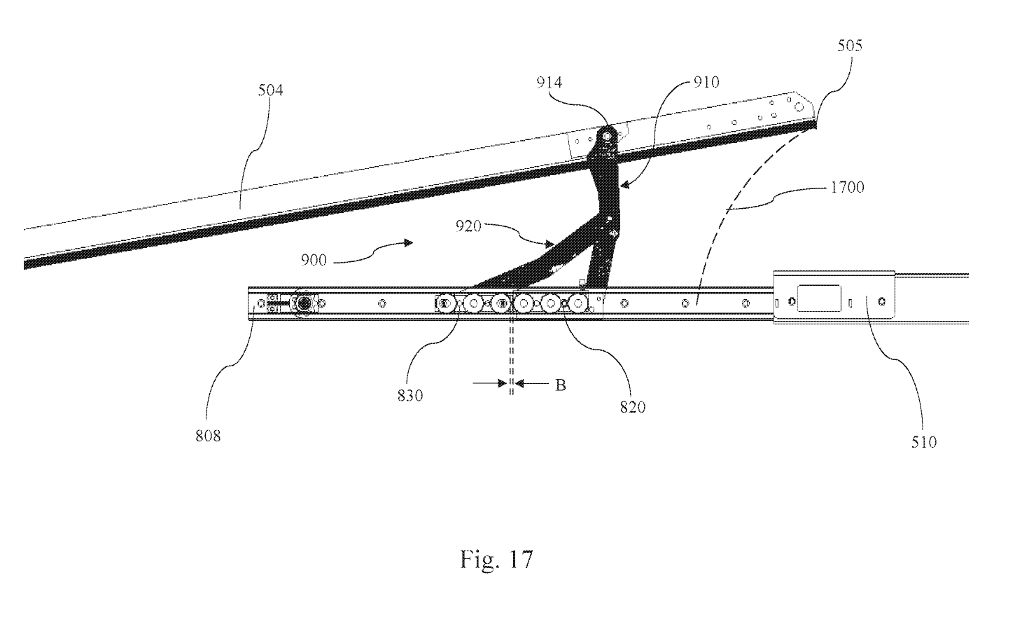

FIG. 16 illustrates a side view of the under-battery access device 500 in the partially deployed configuration, where the guide blocks 710 are approaching the second end of the first linear guide rail 708 and the second linear guide rail 808 is extending outwards from the second end of the housing 510 towards the deployed condition, as illustrated in FIG. 11. The second linear guide rail 808 is semi-transparent to show detail of the first and second guide blocks 820, 830. In the partially deployed configuration, the ramp platform 504 is completely outside of the housing 510, and the inboard end 505 of the ramp platform 504 is in a lowered position. The first and second guide blocks 820, 830 are approaching the second end of the second linear guide rail 808. The first and second guide blocks 820, 830 may be separated by a distance of A. The distance A is constant when the under-battery access device 500 is in the stowed and the partially deployed configurations. In the partially deployed configuration shown in FIG. 16, the hook 1002 is about to engage with the peg 1008 to halt movement of the second guide block 830 relative to the second rail 808. As the hook 1002 engages the peg 1008 and stops the second guide block 820 from further travel along the second linear guide rail 808, the second chain 804 may continue to rotate and move the first linear guide block 820 towards the second linear guide block 830. The first linear guide block 820 may continue to travel along the second linear guide rail 808 until it reaches a distance of B to the second guide block 830. Gap B may be customized based on the performance needed for installation on any vehicle, e.g., the elevation of the vehicle floor. In some cases, distance B may be near zero or zero wherein the first and second guide blocks 820, 830 may contact each other in the fully deployed configuration. This position is illustrated in FIG. 17. As the first guide block 820 travels relative to the second guide block 830 from distance A to distance B, the first and second lifting arms 910, 920 may rotate about the first and second guide blocks 820, 830 to an expanded configuration. The second end 914 of the first lifting arm 910 may rotate relative to the ramp platform 504 and lift the inboard end 505 of the ramp platform 504 in a vertical direction. The inboard end 505 of the ramp platform 504 may travel in an arcuate path 1700. Since the under-battery access device 500 is mounted substantially below the HV battery assembly 150, the arcuate path 1700 allows the ramp platform 504 to avoid contact with the BEV 100 or HV battery assembly 150 while it is being lifted, but allows the inboard end 505 of the ramp platform 504 to travel towards the floor surface 118 of the BEV 100 to rest upon a structure. The structure the ramp platform 504 rests upon may be the floor 118, a door jamb of the BEV 100, or a ledge (not shown) may be provided in the position to support the inboard end 505 of ramp platform 504 in the fully deployed position.

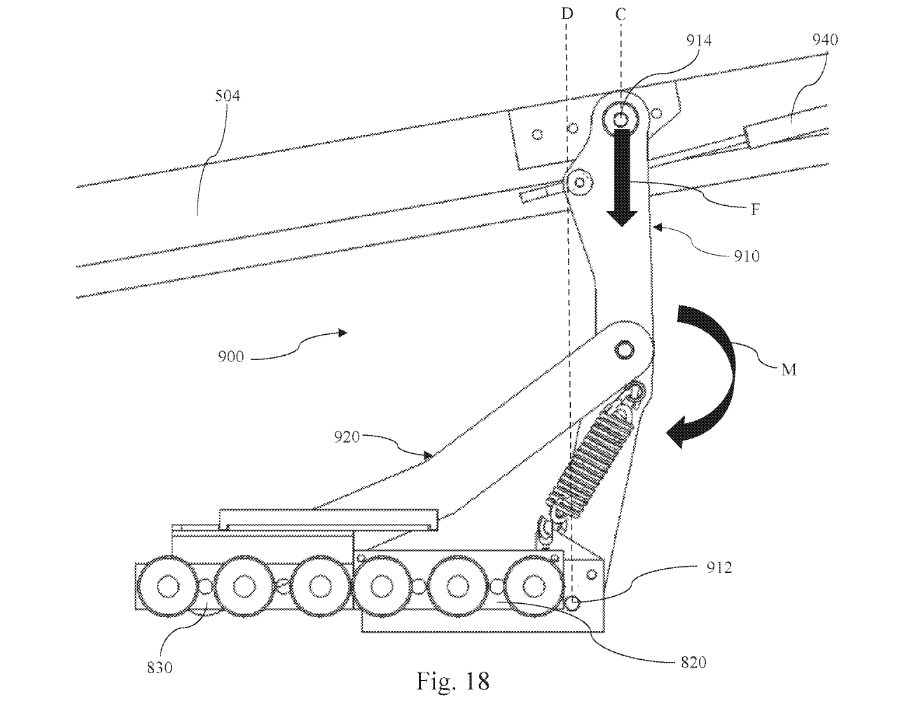

FIG. 18 shows a detailed view of the lifting mechanism 900 in the fully deployed configuration as in FIG. 17. It should be appreciated that the first and second lifting arms 910, 920 are configured to help support the weight of the ramp platform 504, as well as a passenger traversing the ramp platform 504. The second end 914 of the first lifting arm 910 may be configured to rotate such that the second end 914 is further towards the housing 510 than the first end 912 of the first lifting arm 910. This is illustrated by lines C and D. As the line C corresponding to the location of the second end 914 is towards the housing 510, the weight of the ramp platform 504 causes a downwards force F on the second end 914 of the first lifting arm 910, which create a moment M on the first lifting arm 910. The moment M transfers the force to the first end 912 of the first lifting arm 910 to push the first guide block 820 towards the second guide block 830. The second guide block 830 is fixed and prevented from further movement by the stop 1000, so the first guide block 820 contacting the second guide block 830 may be anchored to the housing 510 via the stop 1000. This design feature, which may be considered to be an “over-center lock,” ensures that the load experienced by the ramp platform 504 does not create a force adverse of the lifting mechanism 900 and cause the first and second lifting arms 910, 920 to travel to the collapsed configuration.

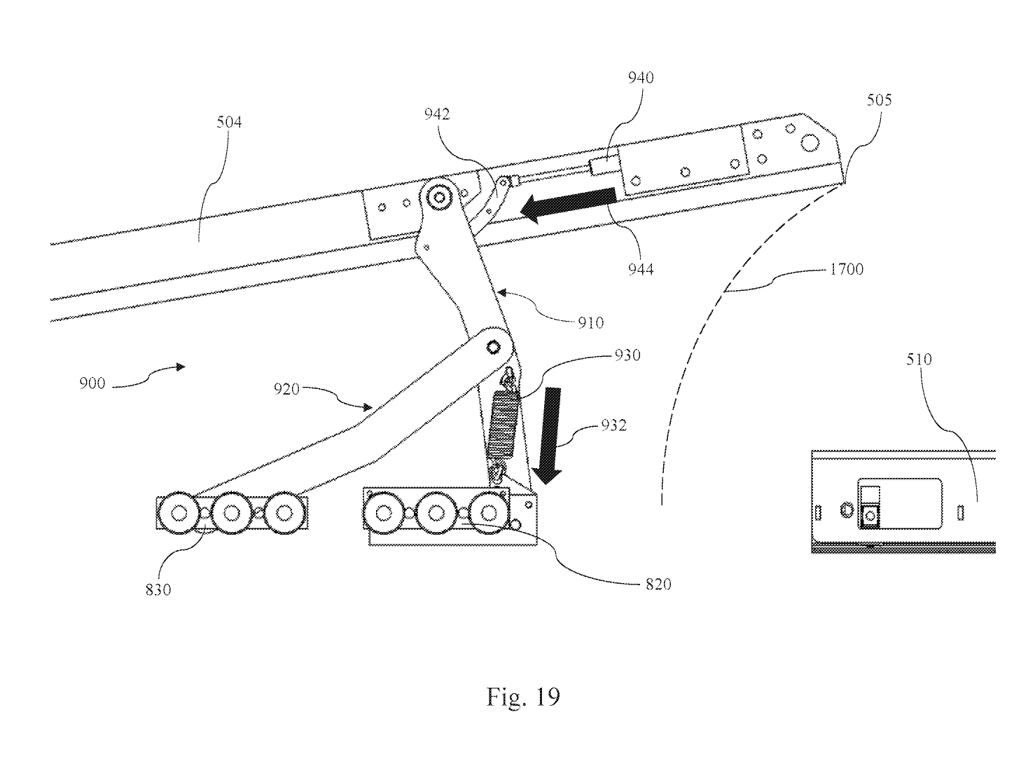

FIG. 19 is a side view of the lifting mechanism 900 for the under-battery access device 500 in a position between the partially deployed and fully deployed configurations, similar to FIG. 14. Linear guide rail 808 is hidden for viewing of the lifting mechanism 900. A first end of a first biasing mechanism 930 may be coupled to the first lifting arm 910. A second end of the first biasing mechanism 930 may be coupled to the first guide block 820. The first biasing mechanism 930 may exert a force on the first lifting arm 910 along the direction of arrow 932. In the shown embodiment, the first biasing mechanism 930 is an extension spring, but in other embodiments may be a coil spring, a torsion spring, a gas spring, or any other known biasing mechanism in the art, but is illustrated here as an extension spring. Lifting mechanism 900 may include a second biasing mechanism 940. A first end of the second biasing mechanism 940 may be coupled to the ramp platform 504. A second end of the second biasing mechanism 940 may be coupled to a first end of a linkage 942. The second end of the linkage 942 may be coupled to the first lifting arm 910. The second biasing mechanism 940 may exert a force on the linkage 942 along the direction of arrow 944, which transfers the force to the first lifting arm 910. In the embodiment shown, the second biasing mechanism 940 is a gas spring, but in other embodiments may be may be an extension spring, a coil spring, a torsion spring, or any other known biasing mechanism in the art, but is illustrated here as a gas spring. In alternative embodiments, as shown in FIG. 14 and 18, the second biasing mechanism 940 may be directly connected to the first lifting arm 910.

The combination of the first and second biasing mechanisms 930, 940 assist the lifting mechanism 900 with the initial lift of the weight of the ramp platform 504. As the first and second lifting arms 910, 920 are moving from the collapsed position, they lack leverage to get the expansion started. The first and second biasing mechanisms 930, 940 assist with this. A secondary function of the second biasing mechanism 940 is that the gas spring dampens the movement of the inboard end 505 of ramp platform 504 along arch 1700. The dampening of the motion reduces the slamming of the ramp platform 504 into another structure when stowing or deploying.

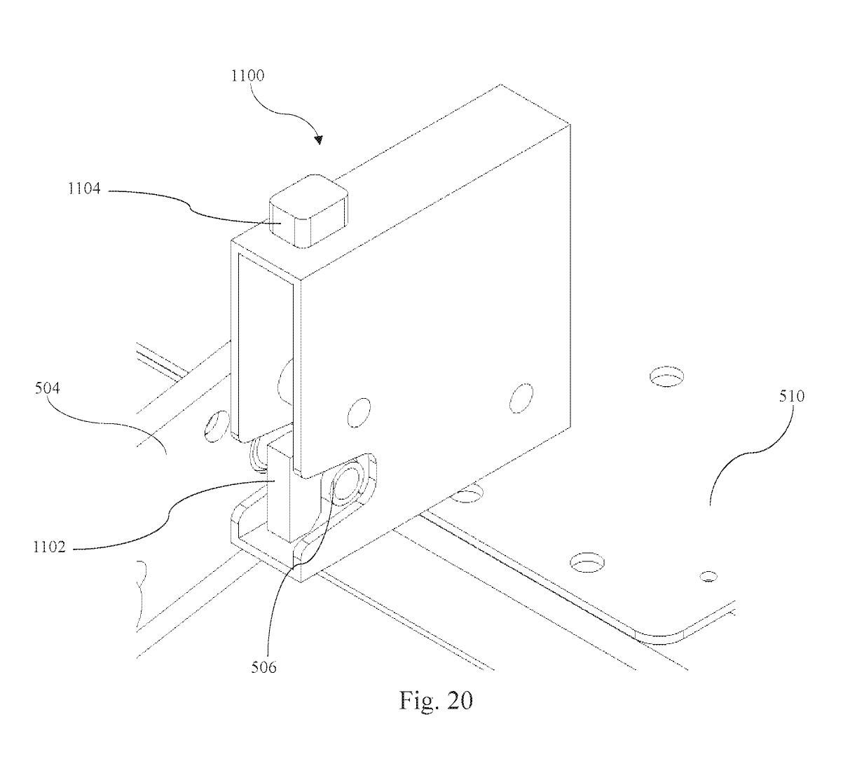

FIG. 20 illustrates a perspective view of a latching assembly 1100 for the under-battery ramp 500. The latching assembly 1100 may be fixedly coupled to the housing 520 and positioned substantially within either the first or second upper housings 512, 514, whichever is on the deploy -side of the housing 510. The latching assembly 1100 may include a latch 1102 configured to releasably engage with a projection or pin 506 of the ramp platform 504. There may be more than one latching assembly 1100 for the under-battery ramp 500, one on each side of the ramp platform 504. One latching assembly 1100 is shown in FIG. 20, but the other side latching assembly 1100 may be of the same construction. Additional latching assemblies 1100 are contemplated. The latch 1102 may be biased to an engaged position such that the latch 1102 may receive the projection 506 as the ramp platform 504 is being transitioned to the deployed configuration and retain it within the latching assembly 1100. The latch 1102 may be biased by a biasing mechanism (not shown). The biasing mechanism may be a coil spring, gas spring, torsion spring, or any other known biasing mechanism. The latching assembly 1100 may include a release 1104 coupled to the latching assembly 1100. In an embodiment with more than one latching assembly 1100, it is contemplated to couple the release 1104 of each latching assembly 1100 to a central release configured to release all the latching assemblies 1100 in the under-battery ramp 500. It is further contemplated that the biasing mechanism may be hydraulically, pneumatically, or electrically powered to actuate the latch 1102 from an engaged position to a disengaged position. The powered biasing mechanism may be controlled by programmable logic based on the position and the movement of the ramp platform 504.

The latching assembly 1100 may be fixedly coupled to the housing 510 in a position such that the ramp platform 504 is temporarily fixed substantially adjacent to the floor surface 118. Absence of a latching assembly 1100 may result in a passenger traversing the ramp platform 504 and causing a force that temporarily causes a gap between the inboard edge 505 of ramp platform 504 and the floor surface 118. The latching assembly 1100 may provide confidence and comfort for the passengers utilizing the under-battery ramp assembly 500.

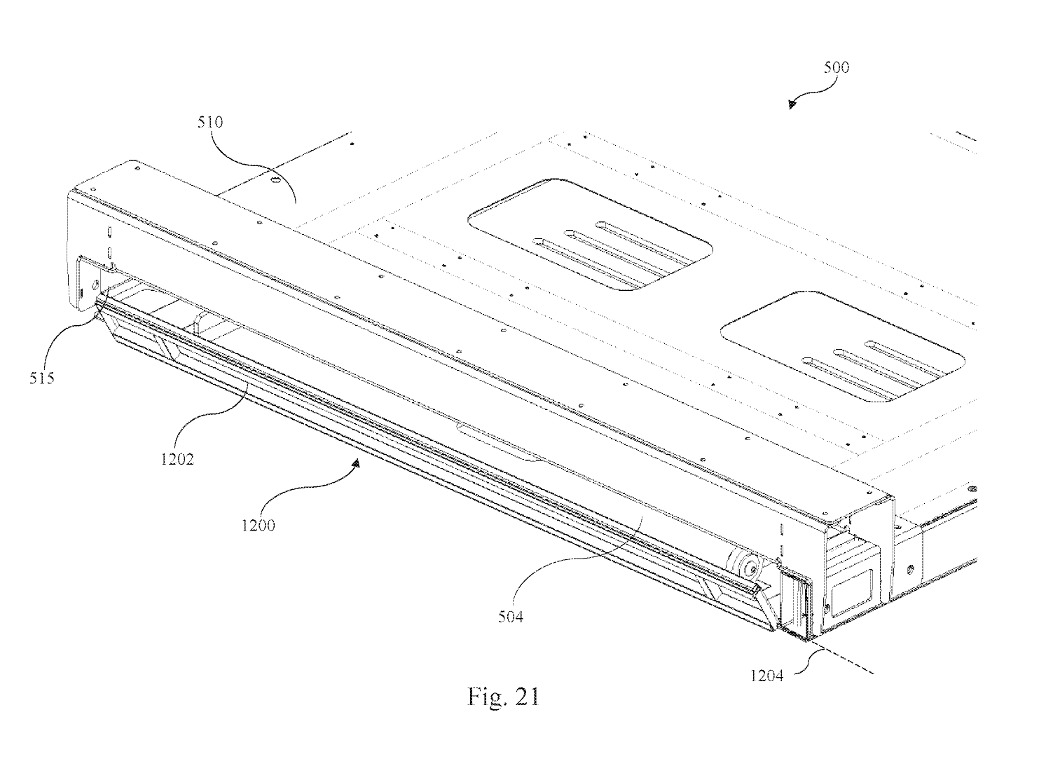

FIG. 21 illustrates a perspective view of a cover flap assembly 1200 for the under-battery ramp assembly 500. Due to the configuration of the under-battery ramp assembly 500, the ramp platform 504 may be stowed in the housing 510 and may be deployed out of an opening 515. The under-battery ramp 500 is configured to couple to the vehicle 100 underneath the HV battery 150, outside of the vehicle body 102. This may leave the under-battery ramp assembly 500 susceptible to debris and elements encountered while operating the vehicle 100 on a road. The cover flap assembly 1200 may be configured to protect the under-battery ramp assembly 500 from contaminants when the ramp platform 504 is in the stowed position inside of the housing 510. The cover flap assembly 1200 may include a flap 1202 that may be rotatably coupled to the housing 510. The flap 1202 may rotate about axis 1204. The flap 1202 may be biased to an upright, or closed position by a biasing mechanism. The biasing mechanism may be an extension spring, torsion spring, gas spring or any other known biasing mechanism. The flap 1202 may be actuated to an opened position that may be approximately 90 degrees from the upright or closed position to allow the ramp platform 504 to transfer from the stowed configuration to the deployed configuration. The flap 1202 may be transferred from the closed position to the opened position when the ramp platform 504 contacts the flap 1202 as it is transferring from the stowed configuration to the deployed configuration. To avoid wear caused by contact between the ramp platform 504 and the flap 1202, the flap may include low friction material such as UHMW to promote smooth contact. Other methods of promoting smoot contact such as a roller with a bearing or other known methods are contemplated herein. It is further contemplated that the flap 1202 may be actuated by a power system. The flap may be actuated by a pneumatic, hydraulic, or electric system configured to open and close by programmable logic based on the position and movement of the ramp platform 504.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A battery electric vehicle comprising a floor, a battery having a battery housing disposed underneath the floor, and a vehicle access device, the vehicle access device including:
a platform configured to provide a wheeled mobility device access to an interior of the battery electric vehicle, wherein the platform is moveable between a stowed position and a deployed position;
at least one component of the drive assembly is at least partially disposed above a lower plane of the battery housing, below an upper plane of the battery housing, and between a side plane of the battery housing and a corresponding side plane of the battery electric vehicle.

2. The battery electric vehicle of claim 1, wherein the platform is below and at least partially underneath the battery housing in the stowed position.

3. The battery electric vehicle of claim 1, wherein the vehicle access device comprises a drive assembly for moving the platform between the stowed position and the deployed position, and wherein the drive assembly comprises the at least one component.

4. The battery electric vehicle of claim 3, wherein the at least one component is disposed above the platform when the platform is in the stowed position.

5. The battery electric vehicle of claim 4,wherein the at least one component comprises a motor.

6. The battery electric vehicle of claim 5, wherein the vehicle access device comprises a housing having a first portion housing the platform when the platform is in the stowed position and a second portion disposed above the first portion, the second portion housing the at least one component.

7. The battery electric vehicle of claim 6, wherein the second portion comprises a structurally reinforced frame to provide side-impact protection for the battery.

8. The battery electric vehicle of claim 6, wherein the housing has a housing length and the platform has an inboard edge, an outboard edge, a first side, and a second side, and wherein the platform has a platform length between the inboard edge and the outboard edge;
wherein the platform length is equal to or less than 6” less than the housing length.

9. The battery electric vehicle of claim 8, wherein the platform length is equal to or less than 3" less than the housing length.

10. The battery electric vehicle of claim 8, wherein the platform length is equal to or less than 1.5" less than the housing length.

11. The battery electric vehicle of claim 8, wherein the vehicle access device is a ramp configured to provide a wheeled mobility device rolling access to an interior of the battery electric vehicle from a ground, wherein the platform is moveable between a stowed position inside of the housing and a deployed position outside of the housing, wherein the access device further comprises at least one linear guide mechanism coupled to the platform, wherein the at least one linear guide mechanism is coupled to one of the first side or the second side.

12. The battery electric vehicle of claim 11, wherein the at least one linear guide mechanism comprises a first linear guide mechanism coupled to the first side and a second linear guide mechanism coupled to the second side.
